(19) United States
(12) Patent Application Publication
(10) Pub. No.: US 2026/0243285 A1
(43) Pub. Date: Aug. 20, 2026

(54) Fastener Assembly

(71) Applicant: Illinois Tool Works Inc., Glenview, IL (US)

(72) Inventors: Lucas Kroeger, Fenton, MI (US); Sean Tomaselli, West Bloomfield, MI (US); Louis Meli, Sterling Heights, MI (US); Scott Liebelt, Eau Claire, MI (US); Dillon McLaughlin, Chippewa Falls, WI (US)

(21) Appl. No.: 19/454,474

(22) Filed: Jan. 21, 2026

Related U.S. Application Data
(60) Provisional application No. 63/760,216, filed on Feb. 19, 2025.

(51) Int. Cl. F16B 5/02; F16B 43/00

(52) U.S. Cl. CPC F16B 5/0258; F16B 43/001

(57) ABSTRACT

Disclosed is a fastener assembly for securing a first component to a second component. The fastener assembly includes an embeddable insert, a base component, and a seal element. The embeddable insert includes a cylindrical body with external threads. The cylindrical body defines a passageway with internal threads configured to engage a fastener. The base component includes a cylindrical body defining an insert cavity configured to receive and retain the embeddable insert, and a seal flange adjacent an opening to the insert cavity. The seal element is positioned on the seal flange and forms a seal between the first component and the base component when assembled.

### RELATED APPLICATION

The present application claims priority to U.S. Provisional Patent Application No. 63/760,216, filed Feb. 19, 2025, and entitled “Fastener Assembly,” which is hereby incorporated by reference in its entirety.

### BACKGROUND

Automotive components require fastening techniques that are simple to manufacture and assemble. Further, fastening techniques should above all be reliable and efficient. Fastening systems sometimes use threaded inserts embedded in plastic or other components to secure screws or bolts, enabling reliable assembly in products like automobiles, computers, and appliances. Metal inserts with internal threads allow parts to be fastened with screws, while threaded studs can be anchored for attachment via nuts.

Various techniques exist for securing inserts or studs in plastic components. Threaded engagement involves screwing the insert into place, while heat-staking—heating a metal insert and pressing it into plastic—creates a fused bond at a relatively low cost. Ultrasonic insertion, which vibrates and embeds the insert, is fast but more expensive. Mechanical insertion, where inserts with knurled or textured surfaces are simply pressed in, is quick but requires costly machining and often provides limited pullout resistance.

A fastening system having an insert design should enable fast, cost-efficient manufacturing with inexpensive materials while ensuring strong resistance to pullout and rotation. Additionally, incorporating a seal can be advantageous in preventing water, dust, and dirt ingress, enhancing durability in various applications. Therefore, despite advancements to date, it would be highly desirable to have a fastening system that simplifies installation while ensuring secure retention after placement and sealing.

### SUMMARY

The present disclosure relates generally to a fastener assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates an isometric assembly view of a fastener system having a fastener assembly with an embeddable insert in accordance with an aspect of this disclosure.

FIG. 2a illustrates an isometric view of the assembled fastener assembly.

FIG. 2b illustrates a top plan view of the assembled fastener assembly.

FIG. 2c illustrates a side elevational view of the assembled fastener assembly.

FIG. 2d illustrates a side elevational cross-sectional view of the assembled fastener assembly taken along cutline A-A (FIG. 2c).

FIG. 2e illustrates a side elevational cross-sectional assembly view of the fastener assembly taken along cutline A-A (FIG. 2c).

FIGS. 3a and 3b illustrate, respectively, isometric and side elevational views of an assembled insert assembly in accordance with another aspect of this disclosure.

FIGS. 4a and 4b illustrate, respectively, first and second isometric views of an assembled insert assembly in accordance with yet another aspect of this disclosure.

FIGS. 4c through 4f illustrate, respectively, first, second, third, and fourth side elevation views of the assembled insert assembly.

FIGS. 4g and 4h illustrate, respectively, top and bottom plan views of the assembled insert assembly.

FIG. 4i illustrates a perspective assembly view of the insert assembly.

FIG. 4j illustrates a perspective cross-sectional assembly view of the insert assembly taken along cutline B-B (FIG. 4i).

FIG. 4k illustrates a perspective cross-sectional assembled view of the insert assembly taken along cutline B-B (FIG. 4i).

FIG. 5a illustrates an isometric view of an insert assembly in accordance with yet another aspect of this disclosure.

FIG. 5b illustrates a top plan view of the insert assembly.

FIG. 5c illustrates a side elevation view of the insert assembly.

FIG. 5d illustrates a cross-sectional side elevation view of the insert assembly taken along cutline C-C (FIG. 5c).

FIG. 6a illustrates a side elevation view of an example embeddable insert with an external surface having waterfall external threads.

FIG. 6b illustrates a side elevation view of an example embeddable insert with an external surface that defines wave external threads formed from a continuous pattern of waves.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a fastener system having a fastener assembly with an embeddable insert. The fastener assembly further provides a sealing element to mitigate ingress and/or egress of fluids, dirt, dust, etc.

In one example, a fastener assembly to secure a first component to a second component comprises: an embeddable insert having a cylindrical body with external threads, wherein the cylindrical body defines a passageway with internal threads configured to engage a fastener; a base component comprising a cylindrical body defining an insert cavity configured to receive and retain the embeddable insert, and a seal flange adjacent an opening to the insert cavity; and a seal element positioned on the seal flange configured to form a seal between the first component and the base component when assembled.

In another example, a fastener assembly to secure a first component to a second component comprises: a base component comprising a cylindrical body defining an insert cavity and a seal flange adjacent an opening to the insert cavity; an embeddable insert having a cylindrical body with external threads configured to engage the insert cavity and internal threads configured to engage a fastener; and a seal element positioned on the seal flange.

In some examples, the embeddable insert is configured to engage the insert cavity of the base component via the external threads.

In some examples, the base component is formed integrally with the second component.

In some examples, the base component is configured to engage a receptacle structure formed in or on the second component.

In some examples, the receptacle structure defines a recess configured to receive at least a portion of the base component.

In some examples, the cylindrical body of the embeddable insert is a tubular shaft having an annular flange positioned at the opening of the insert cavity.

In some examples, the seal element is formed on the seal flange as a single component via an over-molding process or a 2K shot molding process

In some examples, the seal element is configured to mitigate dust, dirt, and moisture penetration through an opening in the first component when assembled.

In some examples, the seal element is a ring formed from a material selected from foam, thermoplastic, or rubber.

In some examples, the base component is a rigid plastic structure, and the seal element is over-molded onto the seal flange.

In some examples, the base component comprises a platen spaced apart from the seal flange, wherein the platen extends radially from the cylindrical body.

In some examples, the cylindrical body of the base component comprises: a first portion positioned between the platen and the seal flange; and a second portion on a side of the platen opposite the first portion.

In some examples, the second portion of the cylindrical body includes a curved lead-in portion to facilitate installation with a receptacle structure formed in or on the second component.

In some examples, the fastener assembly further comprises an annular ring positioned on the seal flange around the insert cavity. The annular ring can function as a compression limiter for the seal element.

In some examples, the base component further comprises buttress elements positioned at a junction between an external wall of the cylindrical body and an underside surface of the platen.

In some examples, the embeddable insert comprises an external thread profile configured as waves.

In some examples, the base component is a rigid plastic structure, and the embeddable insert is metal.

In some examples, the embeddable insert comprises a flange at one end of the cylindrical body.

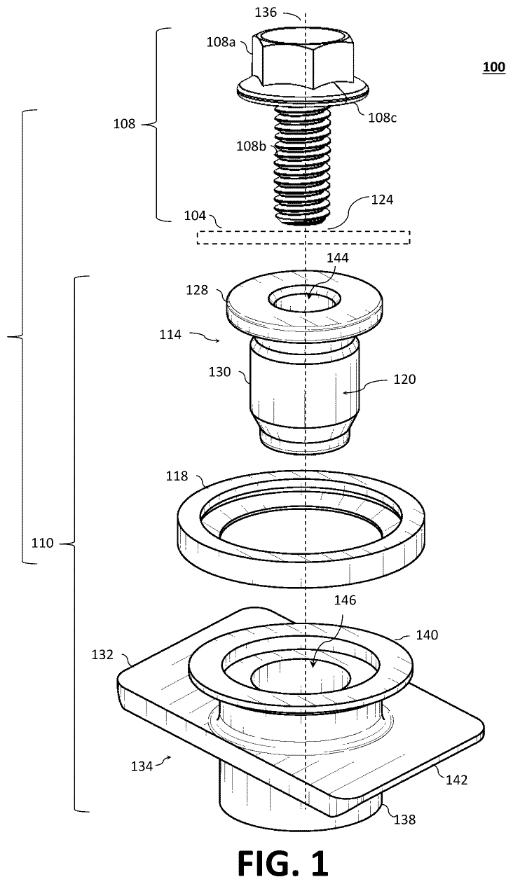

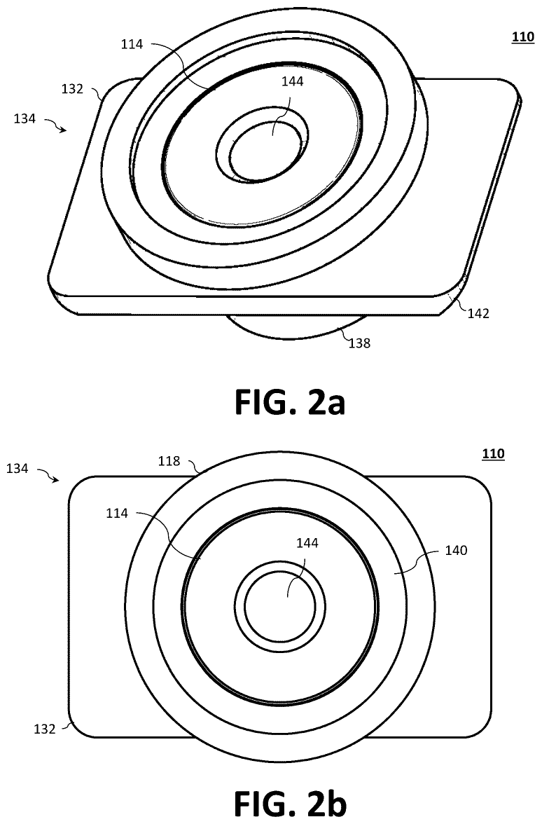

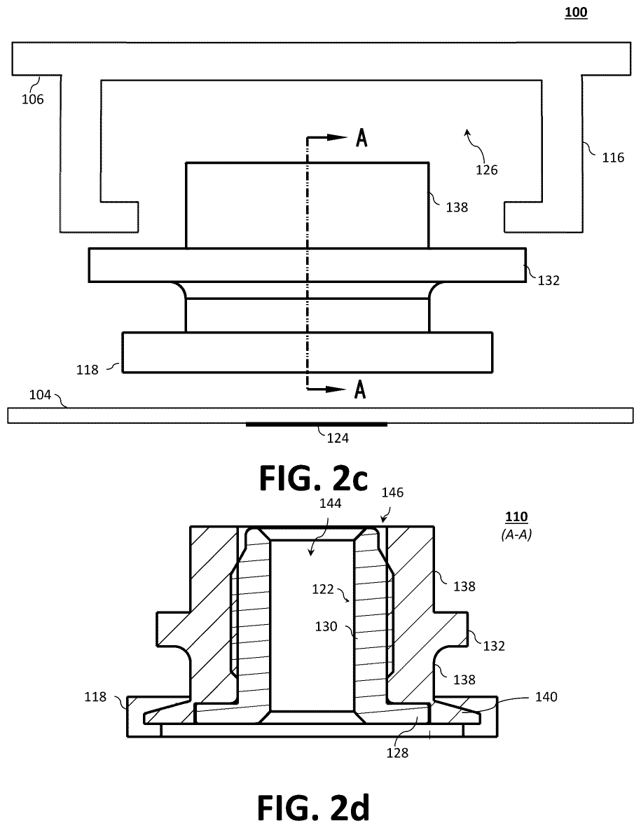

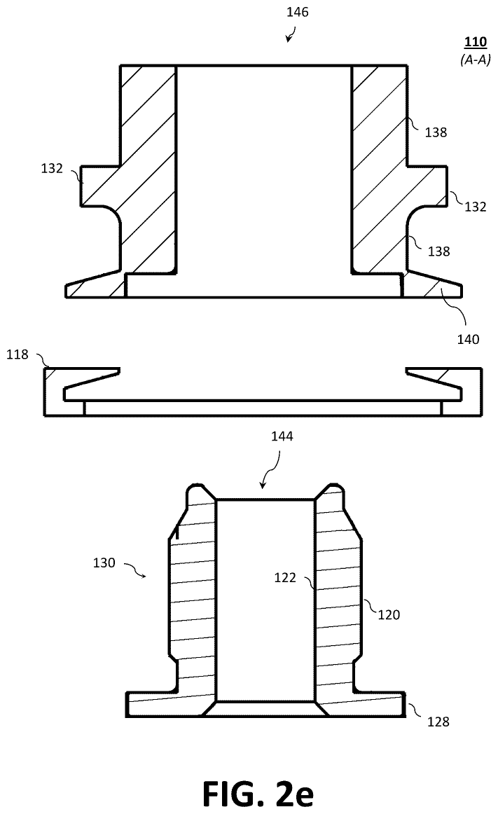

FIG. 1 illustrates an isometric assembly view of a fastener system 100 in accordance with an aspect of this disclosure. The illustrated fastener system 100 includes a fastener assembly 102 having an embeddable insert 114 where additional details can be gleaned from FIGS. 2a through 2e. For example, FIG. 2 a illustrates an isometric view of the assembled fastener assembly 102, while FIGS. 2b and 2c illustrate, respectively, top plan and side elevational views of the assembled fastener assembly 102. FIGS. 2d and 2e illustrate, respectively, a side elevational assembled view and an assembly cross-sectional view of the fastener assembly 102 taken along cutline A-A (FIG. 2c).

A fastener system 100 in accordance with an aspect of this disclosure can include a fastener assembly 102 configured to couple a first component 104 to a second component 106 via a fastener 108 and an insert assembly 110. The illustrated fastener system 100 includes the first component 104, the second component 106, and the fastener assembly 102, which is configured to join the first and second components. In this example, the fastener assembly 102 generally comprises the fastener 108 and an insert assembly 110. The second component 106 is omitted from FIG. 1 for illustrative purposes, but a non-limiting example is illustrated in FIGS. 2c and 2d.

The fastener assembly 102 can be used with, for example, the first component 104, which may be a panel or sheet of metal having an opening 124 (or cutout) to receive the fastener 108 (e.g., a round hole). In the illustrated example, the fastener assembly 102 is configured to join the first component 104 via a fastener 108 and the second component 106 via a receptacle structure (or other feature) formed in or on the second component 106, which is designed to engage a base component 134 of the insert assembly 110. The disclosed fastener assembly 102 provides a robust connection between the first component 104 and the second component 106.

The fastener 108 is illustrated as a male fastener (e.g., a head 108a connected to a collar 108c with an externally threaded shank 108b) configured to engage the embeddable insert 114. The fastener 108 may be a bolt, for example. At least a portion of the shank 108b is externally threaded. The shank 108b is coaxial with the head 108a and the collar 108c. In the illustrated example, the male fastener 108 is a threaded bolt with a hex-shaped head, but other types of fasteners and fastener heads are contemplated. The shank 108b of the fastener 108 passes through the insert assembly 110 (e.g., via a passageway 144 formed in the embeddable insert 114). The passageway 144 can be internally threaded. While the fastener 108 is illustrated as a bolt, a stud (or similar component) can be used in lieu of the bolt.

The insert assembly 110 is illustrated as a multi-component fastener assembly comprising an embeddable insert 114, a base component 134, and a seal element 118.

The base component 134 generally comprises a cylindrical body 138, a platen 132, and a seal flange 140 that is spaced apart from the platen 132. In the illustrated example, the platen 132 and the seal flange 140 extend radially from the cylindrical body 138 (e.g., away from a central longitudinal axis 136 of the fastener assembly 102). The cylindrical body 138 is configured to receive and retain the embeddable insert 114 in an insert cavity 146 formed therein. In the illustrated example, the insert cavity 146 extends entirely through the cylindrical body 138 thereby allowing the shank 108b to pass there through; however, the insert cavity 146 need not extend entirely through the cylindrical body 138. For example, the insert cavity 146 can be closed at one end where the depth of the insert cavity 146 corresponds to the height of the embeddable insert 114. The platen 132 is configured to engage the second component 106 (e.g., via the receptacle structure 116), while the seal flange 140 surrounds the opening to the insert cavity 146 and provides the substrate to which a seal element 118 is applied. In some examples, the platen 132 may define a chamfered edge 142, which serves as a lead in surface to guide or align the platen 132 during assembly (e.g., with the second component 106).

In the various illustrated examples, the base component 134 is a separate component that is configured to couple mechanically with the second component 106 via a receptacle structure 116 (or otherwise). It is contemplated, however, that the base component 134 (or a component thereof) can be integrally-formed with the second component. For example, the insert cavity 146 and/or the seal flange 140 can be formed or otherwise defined by the second component 106. By way of illustrated, the insert cavity 146 can be formed in the second component 106 (e.g., by drilling, boring, etc.) while the seal flange 140 can be formed on the second component 106 (e.g., by additive manufacturing, molding, adhesives, etc.)

The embeddable insert 114 generally comprises a flange 128 and a cylindrical body 130. The flange 128 is generally annular, while the cylindrical body 130 is a tubular shaft with internal threads 122 formed in the passageway 144 and external threads 120 formed on the outer surface of the cylindrical body 130. The cylindrical body 130 is configured to reside within the insert cavity 146 where the flange 128 resides at the opening to the insert cavity 146 (e.g., flush with or generally aligned with the seal flange 140). In some examples, the external threads 120 are self-tapping.

The internal threads 122 correspond to the threading of the shank 108b and are configured to engage with the threaded shank 108b of the fastener 108, while the external threads 120 are configured to cut, dig, or otherwise engage the material of the base component 134 to secure the embeddable insert 114 within the insert cavity 146 and relative to the base component 134. As such, an interior surface of the insert cavity 146 can my smooth or featureless (e.g., non-threaded), where the embeddable insert 114 modified the interior surface of the insert cavity 146 via the external threads 120 when inserted or otherwise installed (e.g., via heat-staking, ultrasonic, mechanical, etc.). For example, FIG. 6a illustrates a side elevation view of an embeddable insert 114 with an external surface having waterfall external threads 120a, while FIG. 6b illustrates a side elevation view of an embeddable insert 114 with an external surface that defines a wave external threads 120b formed from a continuous pattern of waves. Additional details regarding suitable embeddable inserts 114 can be gleaned from commonly-owner U.S. Pat. Nos. 9,080,593 and 9,903,409, which describe external surface for a fastener insert that defines a plurality of wave and waterfall threads.

The fastener assembly 102 may also comprise a seal element 118 to mitigate dust, dirt, and/or moisture penetration through the opening 124. The seal element 118 may be embodied as a ring (e.g., an annulus) fabricated from foam, thermoplastic, rubber, or similar materials. For example, the seal element 118 can be configured to surround the insert cavity 146 and, when assembled with the embeddable insert 114, the passageway 144. When assembled, the seal element 118 can be positioned between the base component 134 and the first component 104. In one example, the base component 134 can be a rigid plastic structure, and the seal element 118 is a softer material that is over-molded onto the base component 134 (e.g., onto the seal flange 140) to form the base assembly 112. In another example, the seal element 118 is formed on the base component 134 via a 2K shot molding process (aka, two-shot injection molding or dual-shot molding) where the seal element 118 and the base component 134 are formed as a single part during one production cycle of a plastic injection molding process. In yet another example, the seal element 118 and the base component 134 can be fabricated as two components where the seal element 118 is later installed on the base component 134 by, for example, stretching the seal element 118 over and/or around the seal flange 140 of the base component 134.

To facilitate attachment via the fastener assembly 102, both the first component 104 and the second component 106 can include one or more engagement features. For example, the first component 104 comprises an opening 124 formed therein configured to receive a portion of the fastener 108. The opening 124 can be formed in the first component 104 during manufacturing or added post-manufacture through a mechanical process (e.g., drilling, cutting, carving, etc.). The second component 106, as illustrated in FIG. 2c, includes a receptacle structure 116 defining a recess 126. A portion of the base component 134 (e.g., the platen 132 and a portion of the cylindrical body 138) can be slid or rotated into the recess 126 of the receptacle structure 116, securing the fastener assembly 102 relative to the second component 106.

The fastener 108 is configured to pass through the opening 124 to mechanically engage the insert assembly 110 via the embeddable insert 114. The male fastener 108 can be rotated relative to the embeddable insert 114 about its axis of rotation (e.g., the central longitudinal axis 136) to join and compress the first component 104 and the second component 106 relative to one another.

Certain components of the fastener assembly 102 may be fabricated from metal via metal-drawing, metal-stamping, or other metal-forming techniques. For example, the embeddable insert 114 can be formed through a metal-forming process. Other components of the insert assembly 110, such as the base component 134, may be fabricated from plastic materials using plastic injection molding, additive manufacturing, or similar techniques. It is also contemplated that components of the fastener assembly 102 could be fabricated using material extrusion (e.g., fused deposition modeling (FDM), stereolithography (SLA), selective laser sintering (SLS), material jetting, binder jetting, powder bed fusion, directed energy deposition, VAT photopolymerization, or other suitable additive manufacturing/3D printing processes).

The first component 104 and the second component 106 may be, for example, automotive panels or other automotive components. Depending on the application, one or both components may be fabricated from metal (or a metal alloy), synthetic or semi-synthetic polymers (e.g., acrylonitrile butadiene styrene (ABS), polyvinyl chloride (PVC), etc.), composite materials (e.g., fiberglass), or a combination thereof. In the automotive industry, example first components 104 include, without limitation, door trim panels, moldings, trim pieces, and other substrates (whether used as interior or exterior surfaces). The second component 106 may be a frame, an automotive panel, or a structural vehicle component, such as doors, pillars (e.g., A-pillar, B-pillar, C-pillar), dashboard components (e.g., cross members, brackets, frames), seat frames, center consoles, fenders, or sheet metal frameworks.

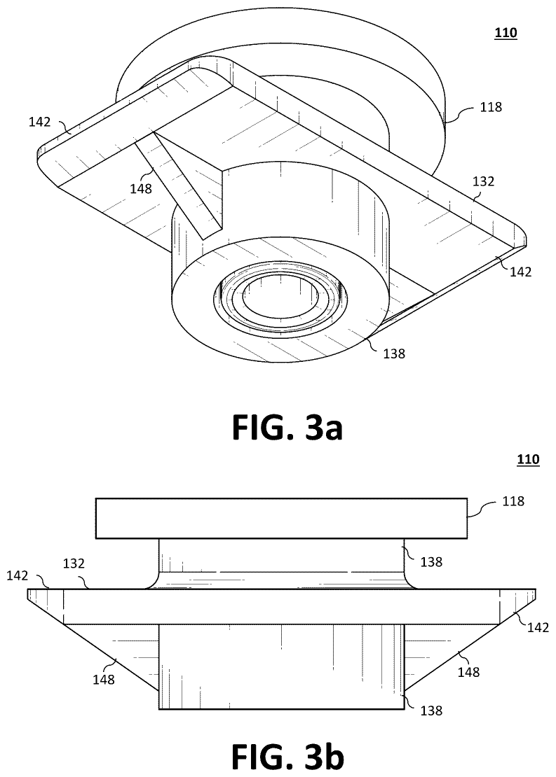

FIGS. 3a and 3b illustrate, respectively, isometric and side elevational views of an assembled insert assembly 110 in accordance with another aspect of this disclosure. The insert assembly 110 is similar to the insert assembly 110 of FIGS. 1 and 2a through 2e except that the insert assembly 110 further comprises a pair of buttress elements 148. In the illustrated examples, the buttress elements 148 are generally triangular and formed at a junction between an external wall of the cylindrical body 138 and an underside surface of the platen 132. The buttress elements 148 are configured to increase rigidity of the base component 134, such as the platen 132.

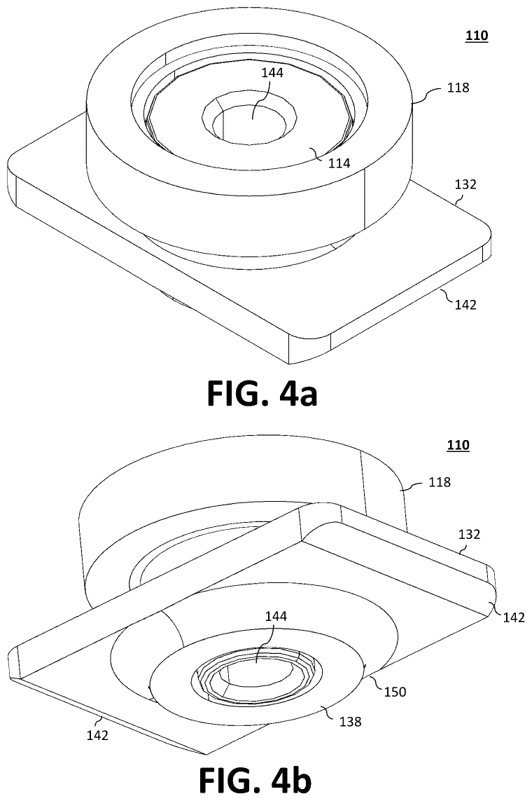

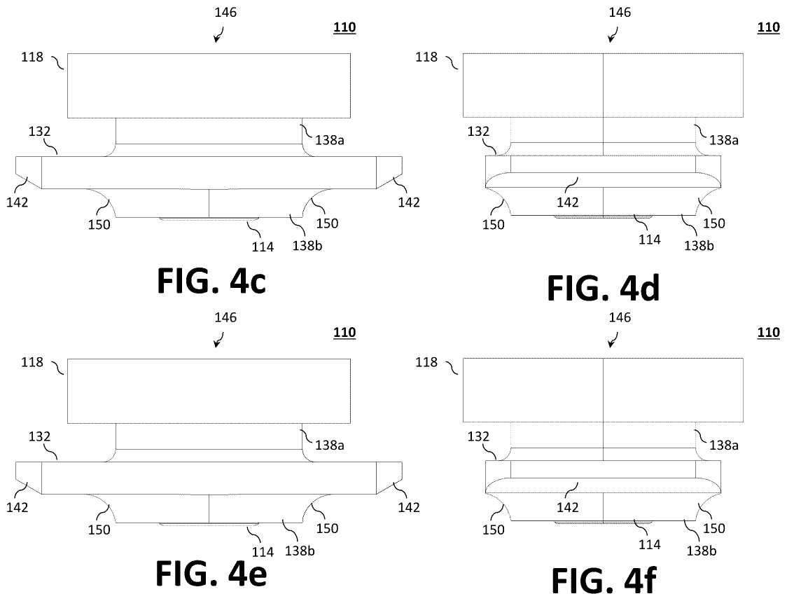

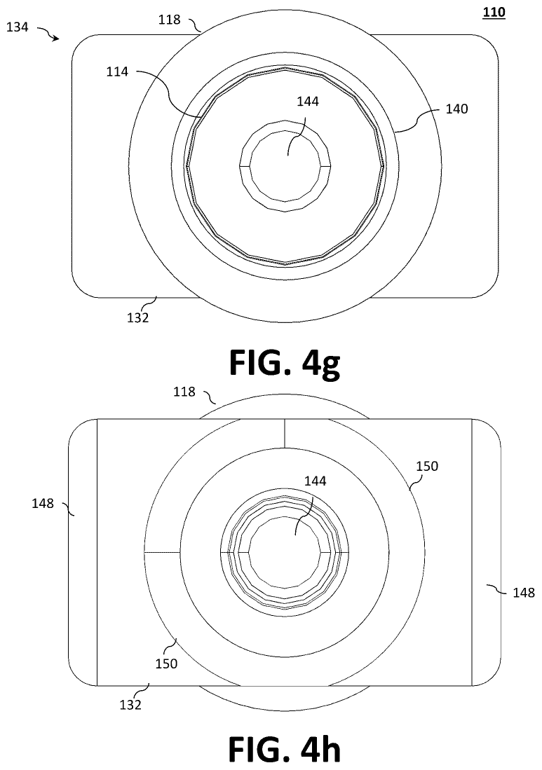

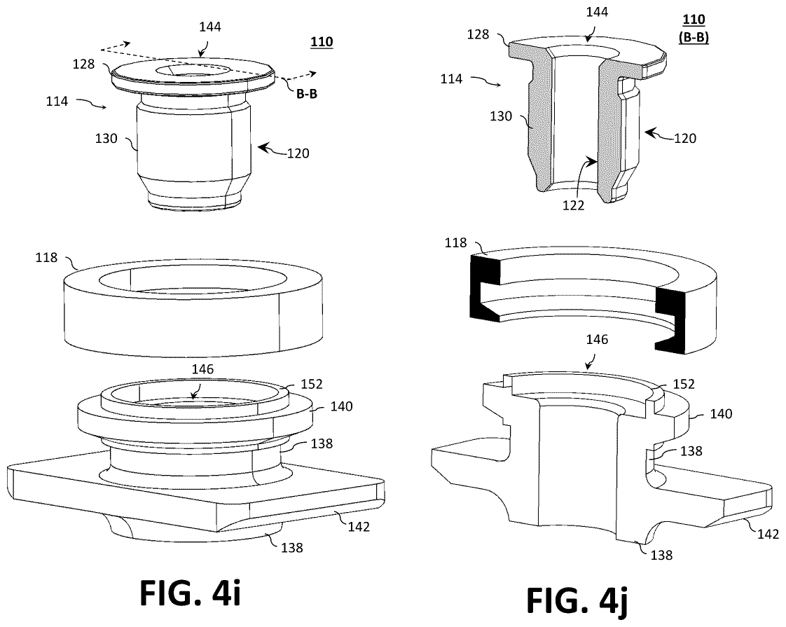

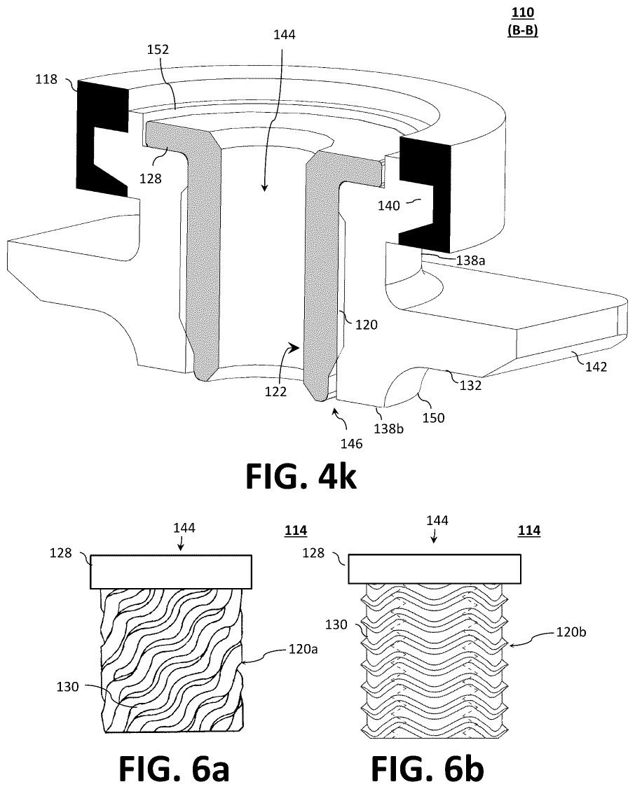

FIGS. 4a and 4b illustrate, respectively, first and second isometric views of an assembled insert assembly 110 in accordance with yet another aspect of this disclosure. FIGS. 4c through 4f illustrate, respectively, first, second, third, and fourth side elevation views of the assembled insert assembly 110, while FIGS. 4g and 4h illustrate, respectively, top and bottom plan views of the assembled insert assembly 110. FIG. 4i illustrates a perspective assembly view of the insert assembly 110, while FIG. 4j illustrates a perspective cross-sectional assembly view of the insert assembly 110 taken along cutline B-B (FIG. 4i) and FIG. 4k illustrates a perspective cross-sectional assembled view of the insert assembly 110 taken along cutline B-B (FIG. 4i).

The insert assembly 110 of FIGS. 4a through 4k is similar to the insert assembly 110 of FIGS. 1 and 2a through 2e with certain exceptions, as summarized herein. First, the base component 134 further comprises an annular ring 152 around the insert cavity 146 adjacent to or positioned on the seal flange 140. When assembled, the annular ring 152 can serve as a compression limiter (e.g., when the seal element 118 is compressed). Second, the dimensions of the cylindrical body 138 relative to the platen 132 are also adjusted to minimize pass through. For example, the cylindrical body 138 includes a first portion 138a between the platen 132 and the seal flange 140 and a second portion 138b on a side of the platen 132 opposite the first portion 138a. The second portion 138b of the cylindrical body 138 is reduced to mitigate interference during assembly with the second component 106. The outer wall of the second portion 138b can also define a curve lead-in portion 150.

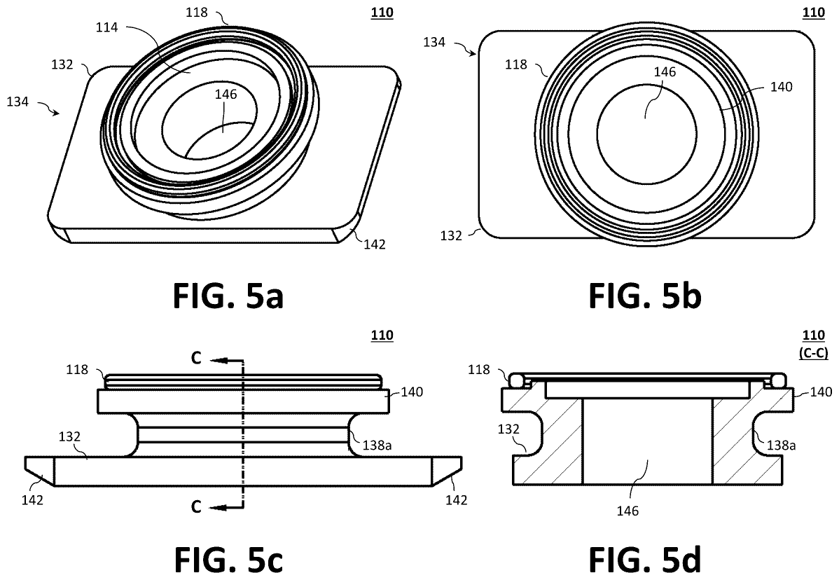

FIG. 5a illustrates an isometric views of an insert assembly 110 in accordance with yet another aspect of this disclosure. FIGS. 5b and 5c illustrate, respectively, top plan and side elevation views of the insert assembly 110, while FIG. 5d illustrates a cross-sectional side elevation view of the insert assembly 110 taken along cutline C-C (FIG. 5c). The embeddable insert 114 is omitted from FIGS. 5a through 5d for illustrative purposes. The insert assembly 110 of FIGS. 5a through 5d is similar to the insert assembly 110 of FIGS. 4a through 4k with certain exceptions, as summarized herein. In this example, the seal element 118 is smaller and is positioned on a single side of the seal flange 140 (rather than wrapping around an edge of the seal flange 140). Further, the second portion 138b of the cylindrical body 138 is omitted to mitigate interference during assembly with the second component 106.

The above-cited patents and patent publications are hereby incorporated by reference in their entirety. While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A fastener assembly to secure a first component to a second component, the fastener assembly comprising:
an embeddable insert having a cylindrical body with external threads, wherein the cylindrical body defines a passageway with internal threads configured to engage a fastener;
a base component comprising a cylindrical body defining an insert cavity configured to receive and retain the embeddable insert, and a seal flange adjacent an opening to the insert cavity; and
a seal element positioned on the seal flange configured to form a seal between the first component and the base component when assembled.

2. The fastener assembly of claim 1, wherein the embeddable insert is configured to engage the insert cavity of the base component via the external threads.

3. The fastener assembly of claim 1, wherein the base component is formed integrally with the second component.

4. The fastener assembly of claim 1, wherein the base component is configured to engage a receptacle structure formed in or on the second component.

5. The fastener assembly of claim 4, wherein the receptacle structure defines a recess configured to receive at least a portion of the base component.

6. The fastener assembly of claim 1, wherein the cylindrical body of the embeddable insert is a tubular shaft having an annular flange positioned at the opening of the insert cavity.

7. The fastener assembly of claim 1, wherein the seal element is formed on the seal flange as a single component via an over-molding process or a 2K shot molding process.

8. The fastener assembly of claim 1, wherein the seal element is configured to mitigate dust, dirt, and moisture penetration through an opening in the first component when assembled.

9. The fastener assembly of claim 1, wherein the seal element is a ring formed from a material selected from foam, thermoplastic, or rubber.

10. The fastener assembly of claim 1, wherein the base component is a rigid plastic structure, and the seal element is over-molded onto the seal flange.

11. The fastener assembly of claim 1, wherein the base component comprises a platen spaced apart from the seal flange, wherein the platen extends radially from the cylindrical body.

12. The fastener assembly of claim 11, wherein the cylindrical body of the base component comprises:
a first portion positioned between the platen and the seal flange; and
a second portion on a side of the platen opposite the first portion.

13. The fastener assembly of claim 12, wherein the second portion of the cylindrical body includes a curved lead-in portion to facilitate installation with a receptacle structure formed in or on the second component.

14. The fastener assembly of claim 1, further comprising an annular ring positioned on the seal flange around the insert cavity.

15. The fastener assembly of claim 14, wherein the annular ring functions as a compression limiter for the seal element.

16. The fastener assembly of claim 11, wherein the base component further comprises buttress elements positioned at a junction between an external wall of the cylindrical body and an underside surface of the platen.

17. The fastener assembly of claim 1, wherein the embeddable insert comprises an external thread profile configured as waves.

18. The fastener assembly of claim 1, wherein the base component is a rigid plastic structure, and the embeddable insert is metal.

19. The fastener assembly of claim 1, wherein the embeddable insert comprises a flange at one end of the cylindrical body.

20. A fastener assembly for securing a first component to a second component, the fastener assembly comprising:
a base component comprising a cylindrical body defining an insert cavity and a seal flange adjacent an opening to the insert cavity;
an embeddable insert having a cylindrical body with external threads configured to engage the insert cavity and internal threads configured to engage a fastener; and
a seal element positioned on the seal flange.
